(19) United States
(12) Patent Application Publication
(10) Pub. No.: US 2013/0054354 A1
(43) Pub. Date: Feb. 28, 2013

(54) GENERATING ADVERTISEMENTS FROM ELECTRONIC COMMUNICATIONS

(71) Applicants: Michael C. Kunz, Seattle, WA (US); Chad S. Estes, Woodinville, WA (US); Wook Jin Chung, Sunnyvale, CA (US)

(72) Inventors: Michael C. Kunz, Seattle, WA (US); Chad S. Estes, Woodinville, WA (US); Wook Jin Chung, Sunnyvale, CA (US)

(73) Assignee: MICROSOFT CORPORATION, Redmond, WA (US)

(21) Appl. No.: 13/219,728

(22) Filed: Aug. 29, 2011

(51) Int. Cl. G06Q 30/00

(52) U.S. Cl. 705/14.49; 705/14.72

(57) ABSTRACT

Techniques involving the creation of advertisements from electronic communications. In one embodiment, a determination is made that a received email includes advertisement information. Elements of the email that can be used in an electronic advertisement are identified, and the electronic advertisement is created using at least the identified elements of the email.

### BACKGROUND

With the advent of global networks and associated electronic communications, marketing has made a significant evolution from largely paper-based advertisements and solicitations to electronic counterparts. Today, electronic mail or “email” has become one of the best mediums for an advertiser to locate a desired audience for advertisement and solicitations. The advertiser may be aware of email addresses in which to send email, and the advertiser can embed graphics and other information into these emails. Delivering a commercial email can theoretically have a high return on investment, as the user may be effectively forced to read through the email subject line-by-subject line before taking action on the email.

However, users may ultimately delete or disregard apparent advertisements or solicitations received via email, and never view the content associated with them. Email recipients can at times feel inundated with communications, and advertising emails may be disregarded if only for reasons of expediency. These and other factors can adversely impact the return on investment for any advertisement or other solicitation.

### SUMMARY

Techniques involving the creation of advertisements from electronic communications. One representative technique includes computer-readable media having instructions stored thereon which are executable by a computer system. The executable instructions can enable a determination to be made that a received electronic communication includes advertisement information. Elements of the electronic communication that may be used in an electronic advertisement can be identified, and the electronic advertisement can be created using at least the identified elements of the electronic communication.

In another representative embodiment, an apparatus is provided that includes at least a receiver, an analyzer module, and an advertisement creation module. The receiver is configured to receive an electronic message addressed to a targeted recipient. The analyzer module is configured to receive the electronic message, and to determine whether the electronic message communicates information that can be formulated into an electronic advertisement. An advertisement creation module is configured to receive the information, and to create the electronic advertisement using at least that information.

In another embodiment, a computer-implemented method is provided that includes receiving an email addressed for a targeted device. At least some of the data in the email is analyzed to determine whether it includes data expressly indicating that it is an advertising email including advertising information. Advertising content is parsed from the email if it is determined to be an advertising email. An electronic advertisement is created using at least the advertising content from the email. The resulting created electronic advertisement(s) may be presented via the targeted device.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram generally illustrating a representative manner for presenting commercial email or other communicated solicitations as advertisements;

FIG. 2 is a flow diagram generally illustrating one embodiment for utilizing emails or other electronic messages as basis information for creating one or more advertisements to present to the user;

FIG. 3 is a flow diagram illustrating an embodiment for creating and presenting advertisements to users based on incoming electronic messages;

FIG. 4 diagrammatically illustrates various features associated with the generation and presentation of advertisements based on incoming email advertisements;

FIG. 5 is a block diagram illustrating representative systems that can process emails and other electronic messages to determine if they are advertising messages, create advertisements therefrom, present the created advertisements, and/or other functions described herein;

FIGS. 6A, 6B and 6C depict various representative examples of apparatuses that facilitate the creation of the electronic advertisements as described herein;

FIG. 7 is a flow diagram illustrating a representative method where a user device receives an email that is configured to explicitly identify it as an advertising email, and the resulting advertisement is presented via the user device;

FIG. 8 depicts a representative computing system in which the principles described herein may be implemented.

### DETAILED DESCRIPTION

In the following description, reference is made to the accompanying drawings that depict representative implementation examples. It is to be understood that other embodiments and implementations may be utilized, as structural and/or operational changes may be made without departing from the scope of the disclosure.

The disclosure is generally directed to electronically presented advertisements. Among other things, the disclosure describes representative manners in which communicated digital information, such as electronic mail (email) and other electronic communication, may provide information from which advertisements may be derived. The created or otherwise derived advertisements may be presented via the user device(s) that receives the electronic communication. Advertisers can target user devices to which the advertisers have appropriate contact information, such as email addresses, text message number, etc., and provide information in the electronic communication from which the advertisements can be created or otherwise obtained for presentation.

The disclosure presents representative manners in which sources of advertisements may direct advertisement information to targeted recipients, while facilitating presentation of a resulting advertisement in a form different to, and/or in addition to, the form of the advertisement information in the communicated message. Electronically communicated messages, such as, for example, email, text messages, and multimedia messages, are popular mediums for advertisers to find a desired audience. While advertisers may send email advertisements to targeted recipients, the recipient would ultimately have to see the email in an inbox or other repository, and open the email to view the advertisement. Typically, the recipient will read through a list of received emails, viewing each subject line-by-line, and decide whether to read, delete, move, store or otherwise manage the email. The present disclosure provides manners for reinterpreting transmitted advertisements and other commercial email, and presenting them to the user as advertisements in a typical advertisement unit or other desired area.

In one embodiment, the received email may never need to be presented to the user, resulting in an email inbox having fewer emails for the user to parse through, while still enabling the commercial messaging to be presented as advertisements in a given advertisement space. Also described herein are representative manners for parsing out information relating to the email or other communicated message, and dynamically constructing an advertisement. As described through representative examples below, advertisements may be created from information expressly placed in the email or other digital communication to create the advertisement, or inherently by reviewing information normally provided in the email or other communication.

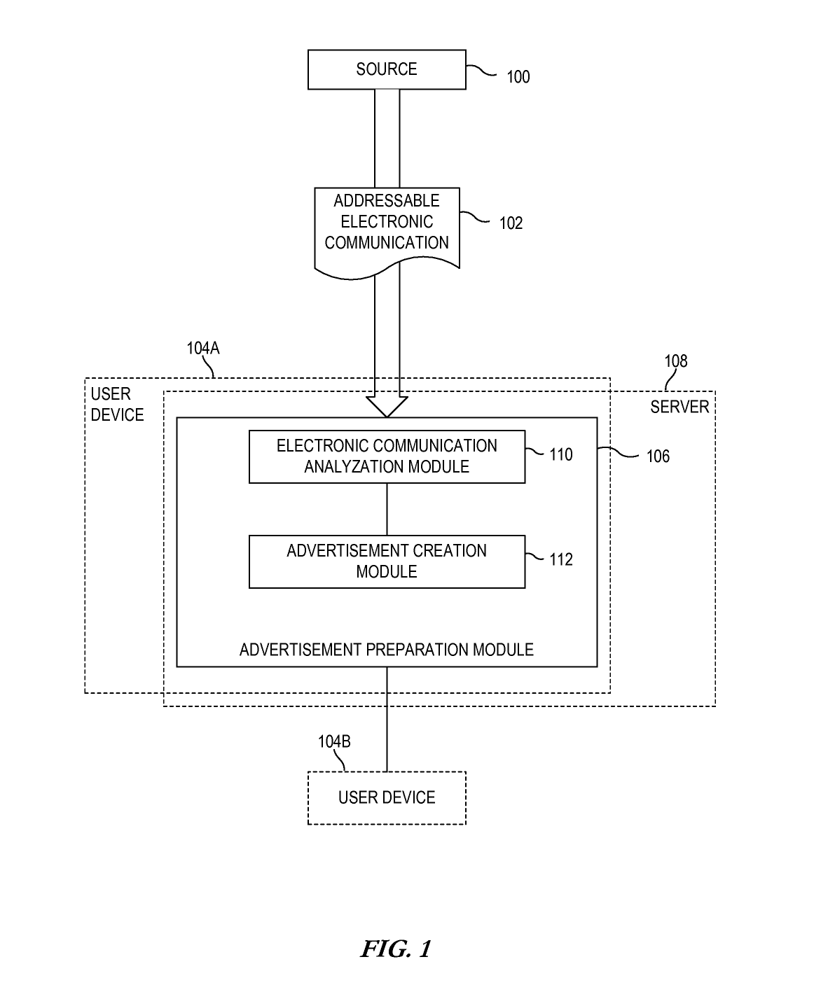

For example, FIG. 1 is a block diagram generally illustrating a representative manner for presenting commercial email or other communicated solicitations as advertisements. A source 100 of the advertisement (“ad”) may be an individual, company, email marketing service provider, or any entity capable of communicating email or other electronic communication to addressable recipients. In the illustrated embodiment, the source 100 communicates one or more addressable electronic communications 102 to one or more recipient devices depicted in FIG. 1 as user devices 104A/104B. The addressable electronic communications 102 may include, for example, email, text or media messages, or any other type of electronic message that may be received by a user device 104A/104B.

In one embodiment, the user device 104A/104B represents any device used to receive the addressable electronic communication 102. For example, the user device 104A/104B may represent a desktop computer, laptop or other portable computer, mobile phone or other mobile communication device, personal digital assistant (PDA), or any other electronic device capable of being configured to receive emails and/or other electronic communications.

The disclosure describes representative manners in which email and other electronic communications may provide information from which advertisements targeted for user devices 104A/104B may be created. The created advertisements may be presented via the user device 104A/104B that receives the email. To facilitate the creation of advertisements from received emails, an advertisement preparation module 106 is provided. The advertisement preparation module 106 may be provided as part of an end user device 104A, such as being implemented in a desktop computing device having an email client configured to at least receive emails. Another example would be a computing device or mobile phone configured to receive text messages. As depicted by user device 104A, the advertisement preparation module 106 may be implemented as part of the same user device 104A that is receiving the email or other addressable electronic communication 102.

In another embodiment, the advertisement preparation module 106 may be provided as part of an intermediate device, server or other computing/communication device. For example, the advertisement preparation module 106 may be implemented in a mail server 108, or other message server or message transfer agent that is logically positioned between the source 100 and the targeted user device 104B of the electronic communication 102. The mail server 108 can assist in the delivery of the electronic communication 102 from the source 100 to the user device 104B. As described more fully below, the advertisement preparation module 106 may be located with these or other devices.

In the illustrated embodiment, the advertisement preparation module 106 includes an electronic communication analyzation module 110, and an advertisement creation module 112. electronic communication analyzation module 110 represents a module capable of receiving the email or other electronic communication/message, and determining whether the electronic communication is a communication relating to advertising. As described below, this determination may be made by analyzing information provided in an email or other message that expressly indicates that advertising information is provided therein. Alternatively, this determination may be made by analyzing the email or other communication to infer that it is an advertisement.

Information obtained from the email or other message may be used to create an advertisement(s) based on the information provided in the email. In FIG. 1, the advertisement creation module 112 creates an advertisement(s) from the information obtained via the electronic communication analyzation module 110. The advertisement(s) may then be presented via a user device 104A/104B in any desired manner, such as within the email itself, outside of the email but within the email client, on a web/Internet page, on a local intranet page, in another client program, etc.

The embodiment of FIG. 1 enables, among other things, one or more advertisements to be presented in lieu of, or in addition to, an email or other message that provides advertising information. For example, a user device may receive an email, which includes information that is converted to an advertisement. The resulting advertisement(s) may be presented via the user device in a typical ad unit or other location. Among other things, this enables advertisements to be presented to a user, even if the email providing the advertising information is not opened by the user in some embodiments.

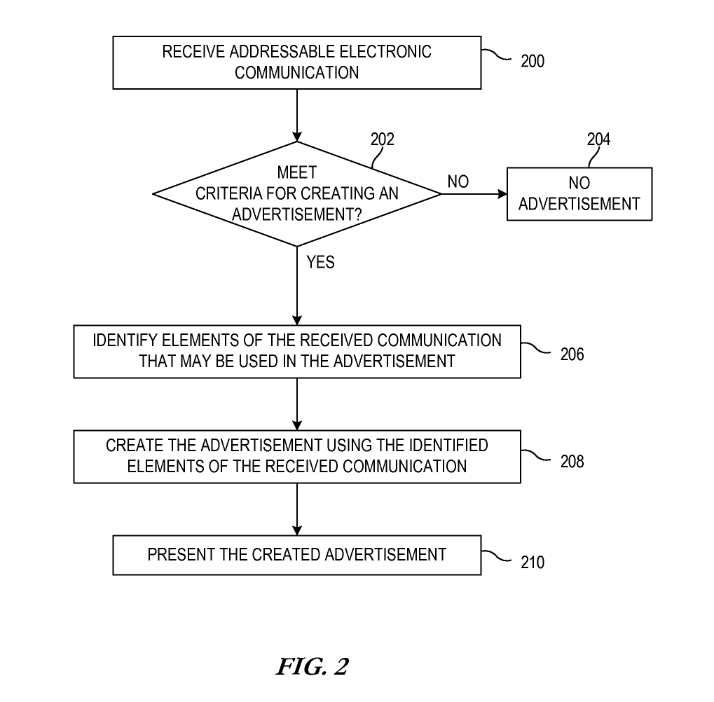

FIG. 2 is a flow diagram generally illustrating one embodiment for utilizing emails or other electronic messages as basis information for creating one or more advertisements to present to the user. The embodiment of FIG. 2 generally provides the ability to expressly or inferentially detect core elements of an email or other electronic message, and use those detected elements to create an advertisement. Particularly, an addressable electronic communication is received as depicted at block 200. As previously noted, the addressable electronic communication may be an email, text message, or other electronic message that can be communicated to a particular user(s). If the received email or other electronic communication does not meet criteria in which an advertisement is to be created, as determined at decision block 202, an advertisement will not be created as depicted at block 204. In one embodiment, determining whether the received electronic communication meets criteria involves determining whether the received electronic communication includes a solicitation or invitation to consider a commercial product or service, although the criteria can be for any solicitation (e.g. donation request, survey request, etc.)

On the other hand, if the electronic communication includes information that meets the criteria as determined at block 202, then elements of that receives communication that may be used in an ultimate advertisement are identified at block 206. For example, electronic communication may be parsed to identify content provided in the body of the email, an attachment of the email, or elsewhere. Using the identified elements of the received electronic communication, the advertisement may be created as shown at block 208. In one embodiment, the advertisement may be created at the local device that receives the email. In another embodiment, the advertisement may be created at a mail server or other intermediate device on the path from the email source to the user device. In yet another embodiment, the identified elements of the receives communication may be transmitted to a device, server, advertising service, or other computing device to create and return the advertisement(s) to the user device.

Ultimately, the created advertisement may be presented to the user as shown at block 210. The advertisement may be presented by way of the device in which user receives electronic communications, or even via a separate electronic device of the user. For example, if properly configured, the user could receive the email at a first device (e.g. work computer), and the created advertisement could be transmitted to a second device (e.g. home computer, mobile phone, etc.). Thus, in one embodiment, the user is allowed to designate another address (e.g. email address, IP address, personal web page, etc.) where created advertisements are presented. In other embodiments, created advertisements are presented in one or more locations, applications, devices, etc., without user involvement. It should be noted that presenting the advertisement may include visually displaying the advertisement and/or audibly presenting the advertisement.

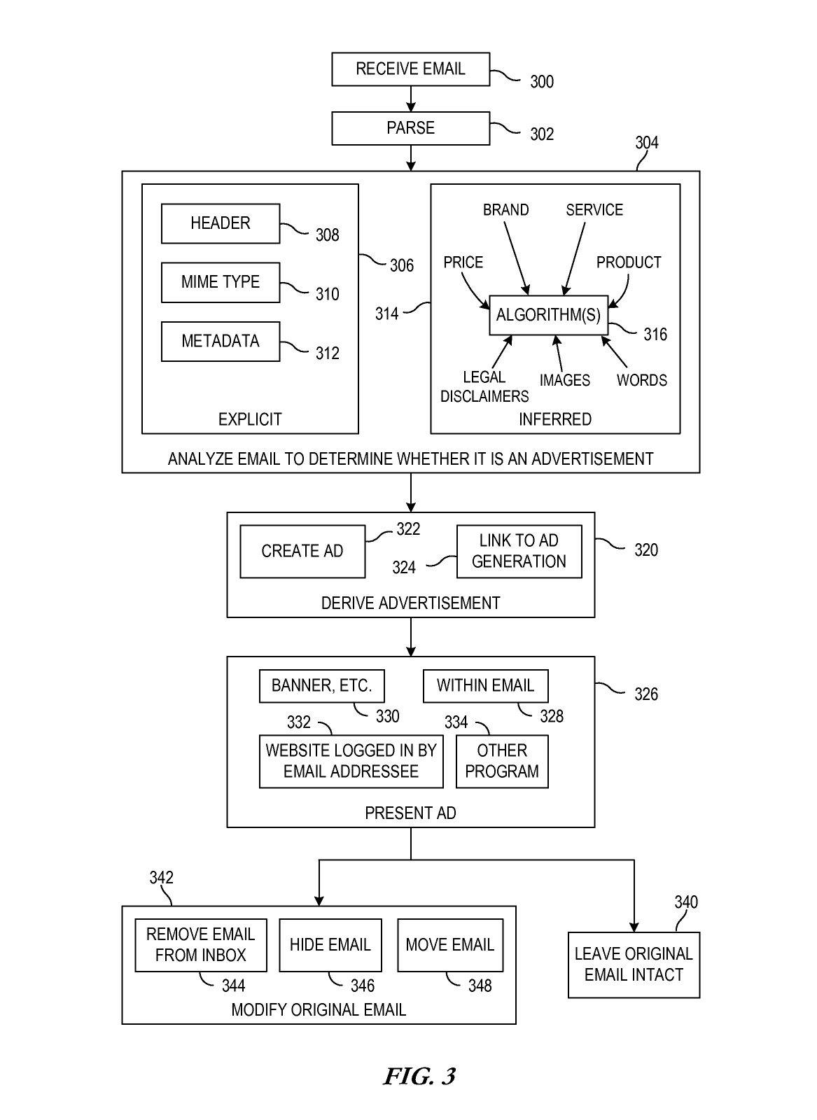

FIG. 3 is a flow diagram illustrating an embodiment for creating and presenting advertisements to users based on incoming electronic messages. In the example of FIG. 3, it is assumed that the electronic messages are email communications. It should also be noted that some features of FIG. 3 may be performed at a mail server or other intermediate device, or alternatively all features may be performed at the local device that receives the email.

At block 300, an email is received. In one embodiment, the email may be parsed as shown at block 302 to identify various parts of the email which can then be analyzed at block 304. For example, the email may be parsed at block 302 to identify the header, header fields, email body, metadata, or other information obtainable from the email. Alternatively, email may be analyzed in its entirety.

In one embodiment, information may be explicitly declared in the email to indicate that the email is to be used in the creation of an advertisement, as depicted by the explicit block 306. For example, the sender or other source of the email may include information that identifies advertisement data, images, target audience, and/or other information that may be recognized when analyzed at block 304. This information may include one or both of the information to enable it to be identified as an advertisement, as well as some or all of the advertisement content itself. In such an embodiment, the email is analyzed at block 304 to determine whether the email is an advertisement by reviewing metadata or other information that was explicitly placed in the email. This information may be provided in various manners, such as by way of the email header 308, by way of a Multipurpose Internet Mail Extensions (MIME) type 310, metadata such as that provided via HyperText Markup Language (HTML), Extensible Markup Language (XML) tags, or the like.

More particularly, advertisement content and/or information identifying the email as an advertisement (hereinafter advertisement information) may be placed in the header 308 in newly created header fields, unused existing header fields, etc. In another embodiment, a new MIME type 310 may be included in the email to provide a body of text or other content to provide the advertisement information. It should be recognized that while a MIME type 310 is used in the example of FIG. 3, any similar email and/or email extension message formatting specification or model may be similarly used. The MIME type 310 is used in the present example simply due to its prolific use in current email technologies.

Thus, a new MIME (or analogous) type 310 may be created to deliberately include the advertisement information. A module configured to analyze the email to determine whether it is an advertisement, such as shown at block 304, will recognize the particular MIME type(s) 310 and obtain the advertisement information. Other recipients of the email that may not be configured to perform the analysis of the emails and creation of advertisements can simply ignore the information associated with the MIME type 310.

Yet another representative manner in which advertisement information may be provided in the email is to add the advertising information into the body of the page as some sort of metadata 312. For example, the advertisement information could be added as metadata 312 by using otherwise unrecognized HTML tags. This could also be accomplished using other markup languages such as XML, or any other manner of annotating information in an email or other message. The advertisement information could be associated with tags or other identifiers that are recognized by the module configured to analyze 304 the email, while other email clients, browsers, and other applications receiving the email could simply ignore or disregard those tags.

In one embodiment, the body of the email may include some or all of the advertisement content itself In such an embodiment, the header 308, MIME type 310, metadata 312 and/or other mechanism may be used to provide the information that explicitly identifies the incoming email as an advertisement email to which an advertisement(s) is to be generated. In other embodiments, any one or more of the header 308, MIME type 310, metadata 312 or other mechanism may also be used to provide some or all of the advertising content that will ultimately be used to create the advertisement.

In the example of FIG. 3, another representative manner in which the email may be analyzed 304 to determine whether it is an advertisement is depicted. Particularly, whether an incoming email is deemed an advertisement email from which an advertisement will be created is inferred from content in the email. This is depicted at block 314 of FIG. 3. In this embodiment, any one or more factors may be processed by one or more algorithms 316 to inferentially determine whether an advertisement will be created from an incoming email. Box 314 illustrates numerous representative factors that may be considered in determining whether the incoming email is deemed an advertisement email from which an advertisement will be created. These factors are merely representative, and do not represent an exhaustive list. For example, information in an email such as product brand names, service names, product names, certain words in the subject line and/or body (e.g. “sale,” credit card or other payment names, “order,” etc.), images, price information, legal disclaimers typically associated with email advertising, etc. In one embodiment, identifiers may be provided in title or heading tags (e.g. H1, H2, etc., for HTML) or in connection with other designated tags or fields. Using any one or more of these and/or other factors, an algorithm(s) may weigh the various factors and ultimately determine whether or not the particular email is deemed a commercial email, advertisement, or other solicitation.

In the event that it is determined at block 304 that a given email meets criteria suggesting that it is a commercial email, advertisement, solicitation, etc., then an advertisement may be derived from information in the email as shown at block 320. Deriving the advertisement may involve creating the advertisement (ad) as shown at block 322. Other manners of deriving the advertisement from the information provided in the email may also be implemented, such as providing some or all of the information obtained from the email to an advertisement generation service elsewhere within the device or remote from the device. More particularly, one embodiment may involve a mail server analyzing the email to determine whether the email is an advertisement at block 304, where the mail server then accesses an advertisement platform via a link 324, or otherwise requests that the advertisement be created at the remote advertisement platform.

In one embodiment, information in the advertisement email includes sufficient information from which the advertisement may be created. For example, an advertisement may already be created within the content of the email, and therefore creation of the advertisement at block 322 involves obtaining the advertisement from the email. As another example, metadata or other information may be presented in the email such as the text for the ad, the size of the graphic display (e.g. A×B pixels), and so forth. In one embodiment, different advertisements may be created for different groups of recipients of the email. For example, for users categorized in one way (e.g. age group), a first advertisement may be created from the received email information, and for users categorized in a second way, a different advertisement may be created from the received email information. Thus, in one embodiment, creating the electronic advertisement includes creating more than one format for the electronic advertisement, and presenting the electronic advertisement in at least one of the multiple formats based on a category of the targeted recipient of the electronic communication.

At block 326, the advertisement is presented. The advertisement may be presented to the user in any number of ways. For example, the ad may be presented directly within the email as shown at block 328. As a more particular example, in an embodiment where the incoming email is retained and opened, the advertisement may be presented in the open email itself The ad may be presented along the top, bottom or side(s) of the viewed body of the email, or may float within the email, etc. the ad may alternatively or additionally be displayed outside of the email body, such as near menu information, header information, status bars, etc. In another embodiment, the ad may be presented outside of the email itself, but within the email client where emails are viewed. The ad may be presented in any location within the email client, such as by way of a banner ad or other known ad as depicted at block 330.

As another example, the created advertisement(s) may be presented via a website 332 or other program 334. For example, a user may have login to a particular website that is affiliated with or otherwise capable of communicating with a mail server that serves emails to the user. In one example, a mail server may create the advertisement as shown at block 322, and then may present that created advertisement(s) on the website to which the user has logged on. In this manner, advertisements directed to a particular user may be presented to the user via another venue. As another example, a mail server or local client that creates the advertisement, or otherwise manages a created advertisement, can present the created advertisement in another program or elsewhere on the user device. For example, an advertisement may be locally created at a user device such as a desktop computer, where the created advertisement is displayed on the user's computer desktop, another application or program such as a web browser, word processing application, etc. The examples described in connection with block 326 illustrate representative examples of where advertisements that have been created from incoming emails may be presented, although numerous other manners may be used in connection with the disclosure.

In one embodiment, the creation and presentation of an advertisement from an incoming email does not impact the email from which the advertisement was created. As shown at block 340, the original email may remain intact. For example, the user may find, open, read, move, delete and/or perform any other action with the incoming email that could otherwise be performed. In another embodiment, the original email is modified in some manner as depicted at block 342. For example, the email may be removed from the user's inbox or otherwise deleted as shown at block 344. In one embodiment, the email is deleted in connection with the creation of the electronic advertisement. For example, whether prior to, contemporaneously with, or after creation of the electronic advertisement, the source email may be deleted since the generated electronic advertisement can effectively take its place. In such cases, the incoming email that included advertisement information is used largely as a vehicle to reach the targeted recipients, with certain advertising information from which an advertisement may be created. As the advertisement is created and presented to the user, there may be no need to retain the email or even present the email to the user. In such instances, the email's purpose is to distribute an advertisement, and may thereafter simply be removed from the user's inbox, or deleted at an upstream mail server before being delivered to the user.

In the case where a mail server or other intermediary device directs incoming emails to the users email client, the mail server itself may delete the email without ever delivering it to the user's email client. In such an embodiment, the mail server may provide the advertisement information from the email, or the email itself, to an advertisement platform or other service to create and present the resulting advertisement(s) to the user. Alternatively, an advertisement creation module at the mail server may create the advertisement from the email, and present the ad to the user via a website or other application to which the mail server is affiliated or can otherwise communicate with.

Block 342 also illustrates other manners in which the original email may be modified. The email may simply be hidden 346 from the user at the users email client, such that it is received but not presented to the user. In such an embodiment, a processor or other module may be configured to delete the email once the advertisement has been created therefrom. In yet another embodiment, the incoming email from which the advertisement is created may be moved to a particular inbox or inbox directory, storage directory, electronic trash bin, etc. The examples associated with block 342 are provided merely as representative examples, as any type of modification of the email may be configured for use with the present disclosure.

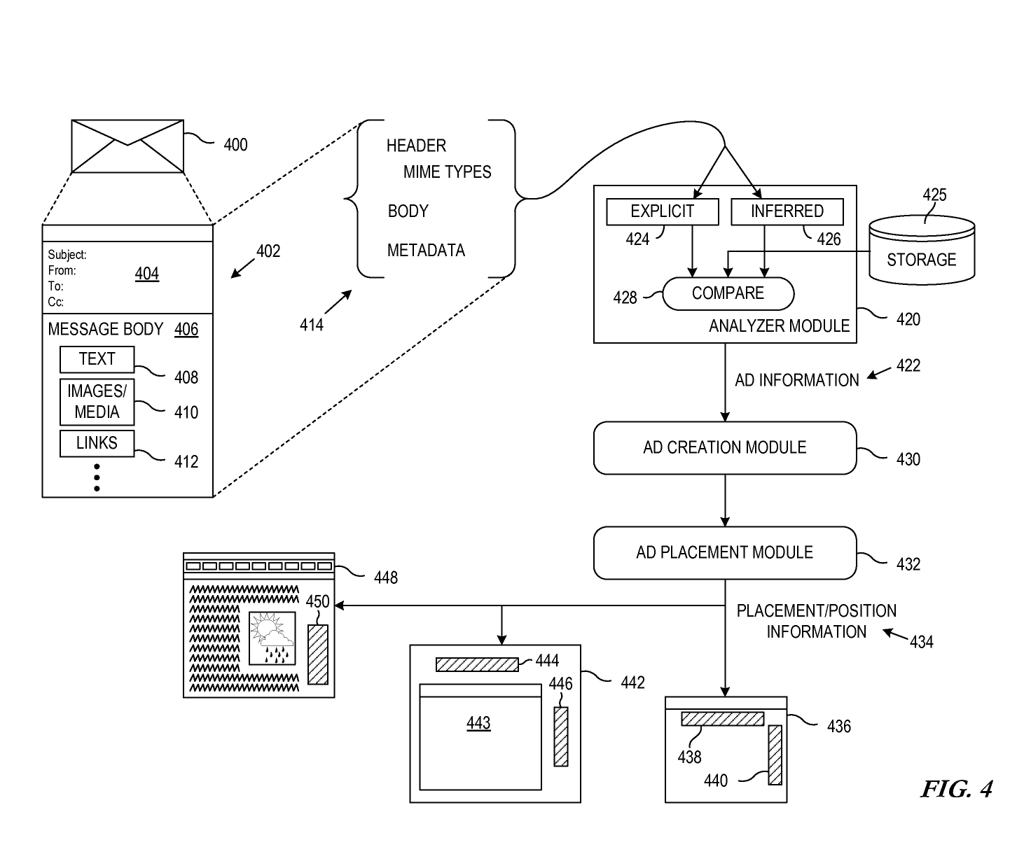

FIG. 4 diagrammatically illustrates various features associated with the generation and presentation of advertisements based on incoming email advertisements. In this example, an incoming email is depicted by mail envelope 400 which is shown in greater detail by email message 402 which is what is viewed by the user. The message 402 may include viewable header information 404, such as a subject, identifications of who the email is from and directed to, etc. The presented email 402 may include a message body 406, which may include any one or more of items such as text 408, images/media 410, links 412, etc. Email information 414 is an example of the information that makes up the presented email 402, which may include header information, body, etc. The header may include MIME type tags or similar tags. As previously noted, a new MIME type(s) may be used to identify that the email information 414 includes advertising information from which an advertisement may be created. Other data or metadata may be included anywhere in the email information 414.

FIG. 4 depicts some representative modules that may be implemented in hardware or programmable hardware, such as one or more programmed processors. The analyzer module 420 may be implemented using, for example, a processor programmed with instructions to analyze and determine whether an incoming email 400 includes ad information 422. The analyzer module 420 may parse the email information 414 to locate indicators that expressly or implicitly indicate the email is an advertisement email, and also to locate advertising content in the email information 414. The analyzer module 420 may initiate the analysis in connection with any desired trigger, such as when the email is received in a user's inbox (e.g. a local email client's inbox), when the email is opened or otherwise viewed, when a mail server receives the email, etc.

As noted above, the indicators that identify the email as having advertisement information may be explicit or inferred indicators. Regarding explicit indicators, a determination of whether an incoming email 400 includes ad information may be made by analyzing explicit information 424 provided with the email information 414. Such explicit information 424 may include one or more designators in the email header, body, or elsewhere to indicate that the incoming email includes advertising information. For example, XML or HTML formatting could be used to essentially declare the email as an advertising email. Reference information may be stored, such as in storage 425, to be compared using a compare module 428 to information in the email that may explicitly designate it as an advertising email.

Alternatively, email information 414 can be analyzed by the analyzer 420 to infer that an incoming email 400 includes advertising information to be converted into an advertisement(s). For example, metadata, information in the body or header of the email information 414 can be analyzed by the analyzer module 420 to infer that an incoming email 400 is an advertisement email. Certain terms, phrases, numbers, symbols, etc. may be obtained from the email information 414, and the compare module 428 may compare the inferred information 426 to reference information stored in the storage 425.

In the event that the analyzer module 420 explicitly or inferentially deems the incoming email 400 to be in advertising email, information provided by way of the email is provided to the ad creation module 430. This information, depicted as the ad information 422, may include text, images, video, and/or other content that will be used in the creation of an advertisement. In one embodiment, creation of an ad via the ad creation module 430 may be accomplished by taking at least some of the elements detected or obtained by the analyzer module 420 and, depending on which elements are present, filling in a template with the content. Thus, the ad creation module 430 may use the ad information 422 to create the advertisement, and provide the resulting advertisement to the ad placement module 432. In other embodiments, the ad information 422 may include a link(s) to content elsewhere that may be used in the creation of the advertisement.

The ad placement module 432 represents the module that determines where the resulting advertisement should be positioned and/or is responsible for introducing the resulting advertisement at the determined position. The resulting placement/position information 434 may place the advertisements within the advertising email itself This is depicted at email 436, where two advertisements 438, 439 that were created from the original advertising email 400 are presented in the email 436. An email client 442 or other user agent may facilitate viewing of the email 443. In this embodiment, the ads 444, 446 are presented outside of the email 443, yet within the email application. In still another representative example, the advertisement may be placed in a different window, program, or even user device. For example, FIG. 4 illustrates a computer application 448, such as a web browser page, where the resulting advertisement 450 is presented. The created advertisements may be placed wherever desired. The representative emails 436, email clients 442, application 448 or other area for displaying the resulting advertisements may be visually presented on a display of the user device.

The created advertisement may display or otherwise present information that the viewer can see, hear, etc. Selecting the created advertisement may reveal information such as coupons. In one embodiment, selecting the created advertisement operates as a link to at least one other location, such as the advertiser's website. In yet another embodiment, selecting the created advertisement provides a link to the advertising email from which the advertisement was created. Thus, selecting the advertisement may link back to open up the email that caused creation of the ad. This may be used where the space for an advertisement is limited relative to the space available in an email to provide the advertising information. Therefore, since the advertisement may be created from the incoming email before the user has opened the email or is even aware of the email, one embodiment involves opening the email when the created advertisement is selected (e.g. “clicked on”).

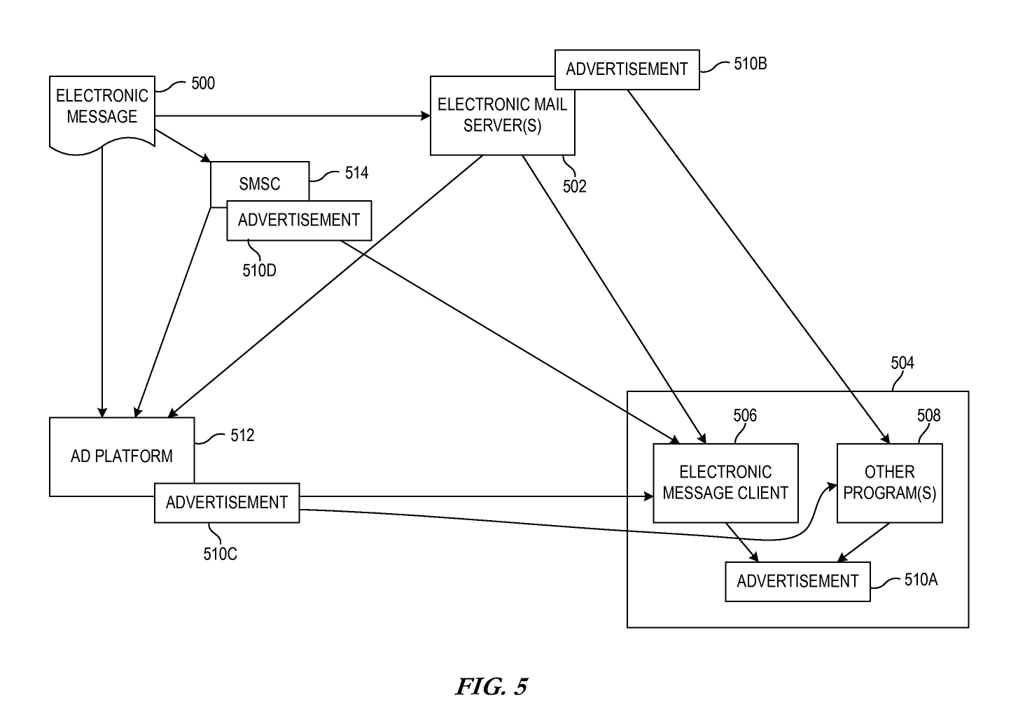

FIG. 5 is a block diagram illustrating representative systems that can process emails and other electronic messages to determine if they are advertising messages, create advertisements therefrom, present the created advertisements, and/or other functions described herein. In the example of FIG. 5, it is assumed that electronic message 500 is addressed to the user device 504. The electronic message 500 may represent an email, a text message, a multimedia message, or other electronic message that can be targeted for the user device 504. Assuming for purposes of example that the electronic message 500 represents an email, the email may be routed to the user device 504 by way of one or more electronic mail servers 502. In one embodiment, the user device 504 receives the email via the electronic message client 506, which in this example represents an email client. The electronic message client 506 may be a locally-stored email application, a web-based or other network-supplied email application, etc. The electronic message client 506 or other designated program(s) 508 may locally process the incoming email by analyzing it to determine if it is an advertising email, creating an advertisement therefrom, directing the created advertisement to an appropriate place for viewing by the user, etc. This is depicted by the advertisement 510A provided by the electronic message client 506 and/or other program(s) 508. Such an advertisement 510A may be presented as part of the electronic message client 506, part of another program 508, etc.

In another embodiment, at least some of the functions described herein are handled at the electronic mail server 502. For example, electronic mail server 502 may receive the email or other electronic message 500, and analyze it to determine whether it is an advertising email before ever providing the email to the user device 504. Alternatively, the mail server 502 may analyze the incoming email to determine whether it is an advertising email while also delivering the email to the user device 504. In such cases, the mail server 502 may use information from the incoming email targeted for the user device 504 in order to create an advertisement 510B. The advertisement 510B may then be viewed via the user device 504 by way of some program 508, which could include the electronic message client 506 as well. In one embodiment, the advertisement 510B may be provided to a program 508 such as, for example, a web-based email application used by the user device 504.

In yet another embodiment, the electronic mail server 502 may provide the email, or information parsed from the email, or a created advertisement to an advertising (ad) server or platform 512. The ad platform 512 may be used to introduce advertisements 510C into the user device's 504 computing experience. For example, the ad platform 512 may introduce advertisements 510C into web pages viewed by the user of the device 504, or other programs that may include an ad unit in which advertisements may be presented. As depicted in FIG. 5, an ad platform 512 may be configured to directly receive the electronic message 500 (or a duplicate of the electronic message sent to the mail server 502) in order to analyze the email and create the advertisement 510C. In embodiments where the electronic message 500 is provided to a mail server 502, ad platform 512, or other intermediary device, the original electronic message 500 may or may not ultimately be delivered to the user device 504. In other words, in some embodiments the electronic message 500 is used as a means to provide the advertisement information to an intermediary device (e.g. mail server 502, ad platform 512, etc.) in order to ultimately create an advertisement therefrom.

In one particular example, a user may utilize a browser or other program 508 to reach a web-based email application. When logging in to such a website, the user may first be brought to a home page for that website, from which the user can click or otherwise select to be directed to the web-based email inbox. In such an example, the ad platform 512 or other entity responsible for placing advertisements on that web-based home page (or other page at that site) can obtain or create an advertisement from the email information, and present the ad on that home page or other page. In this manner, the user may be presented with an ad from an email directed to him/her, while potentially being unaware that the email is even in his/her inbox. In one embodiment, selecting the ad may bring the user to the advertisement email that initiated creation of the advertisement in the first place. This concept may apply to any “upstream” website. For example, where a first website includes a link to, or is otherwise affiliated with, a second site (such as to a web-based email application), the advertisement may be presented at the first website. If the user clicks on or otherwise selects the ad from the first website, the email at the second site may be presented to the user.

Another embodiment recognizes that electronic messages 500 may come in numerous forms. In addition to email, other electronic messages such as text messages, multimedia messages or other addressable electronic messages may be targeted to a user device 504. In one embodiment, it is assumed that the electronic message 500 represents, for example, a text message (e.g. short message service or “SMS” message) that may be sent in a mobile telephone network that delivers text messages. The text message may be received by a short message service center (SMSC) 514 or other network element in the mobile network that delivers text messages. An analyzing module and a creation module may be provided at the SMSC 514 or other network element that ultimately creates an advertisement 510D that can be provided to the user device 504 or presented to the user in other manners (e.g. providing to a website to which the user of device 504 is, or can, log onto). The text message may include the information to be used in the creation of the advertisement 510D, or it may include a link(s) or other address where the appropriate advertisement may be retrieved. In this manner, an addressable electronic message 500 represented by a text message may be used as the vehicle in which to initiate the creation and ultimate placement of an advertisement 510D. It should be noted that other similar messaging technologies such as multimedia mess aging service (MMS) may similarly be used to ultimately create an advertisement as described herein. It should also be recognized that the user device 504 may be a desktop computing device, portable computing device, smart phone or other mobile device, etc.

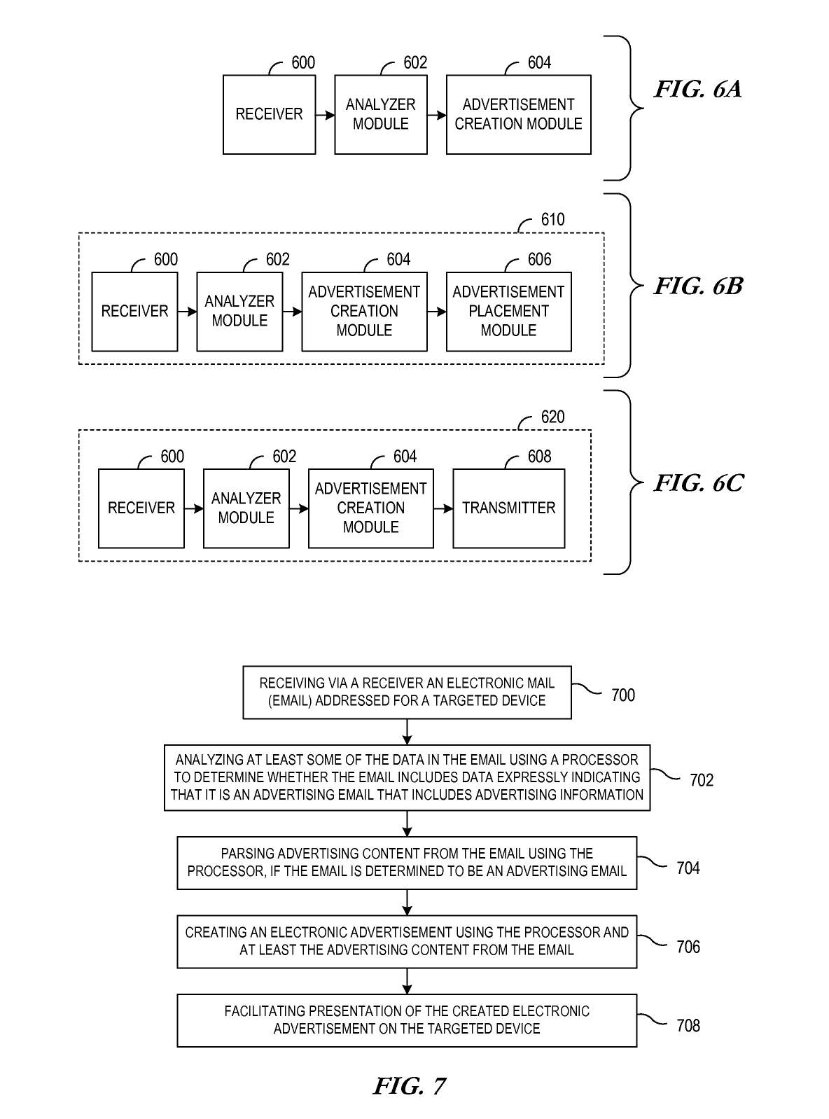

As noted in connection with FIG. 5, various entities may receive and process the email or other electronic message. FIGS. 6A, 6B and 6C depict various representative examples of apparatuses that facilitate the creation of the electronic advertisements as described herein. Like reference numbers are used in FIGS. 6A, 6B and 6C for corresponding modules.

In the embodiment of FIG. 6A, the responsible apparatus includes at least a receiver 600, an analyzer module 602, and an advertisement creation module 604. The receiver 600 is configured to receive an electronic message (e.g. email, text message, etc.) addressed to a targeted recipient. The analyzer module 602 is configured to receive the electronic message, and determine whether it communicates information that can be formulated into an electronic advertisement. If the electronic message included that information, the advertisement creation module 604 uses at least that information to create the electronic advertisement.

In the embodiment of FIG. 6B, the receiver 600, analyzer module 602 and advertisement creation module 604 are implemented at a user device 610 of the targeted recipient. The user device may further include an advertisement placement module 606 that is configured to cause the electronic advertisement to be presented via the user device 610. Such presentation may include one or more of displaying the electronic advertisement via a display, audibly reading the electronic advertisement via speakers, etc.

In the embodiment of FIG. 6B, the receiver 600, analyzer module 602 and advertisement creation module 604 are implemented at a message server 620 (e.g. mail server, SMSC, etc.) in a communication path between a source of the electronic message and a user device of the targeted recipient. In one embodiment, the mail server 620 further includes a transmitter 608 configured to transmit the electronic advertisement to the user device. The examples of FIG. 6A-6C are merely representative, as various other configurations may also be implemented in accordance with the disclosure.

One embodiment involves performing operations according to the disclosure at the device that receives an email. For example, an email application may be configured to create the advertisement from an incoming email. FIG. 7 is a flow diagram illustrating an example where the message transmitted is an email, the device performing the operations is the user device that receives the email, the email is configured to explicitly identify it as an advertising email, and the resulting advertisement is presented via the user device. More particularly, the representative method includes receiving an email addressed for a targeted device, which in turn analyzes at least some of the data in the email to determine whether it includes data expressly indicating that it is an advertising email that includes advertising information. Advertising content is parsed from the email if the email is determined to be an advertising email, and the electronic advertisement is created using at least the advertising content from the email. The created electronic advertisement may be presented via the targeted device.

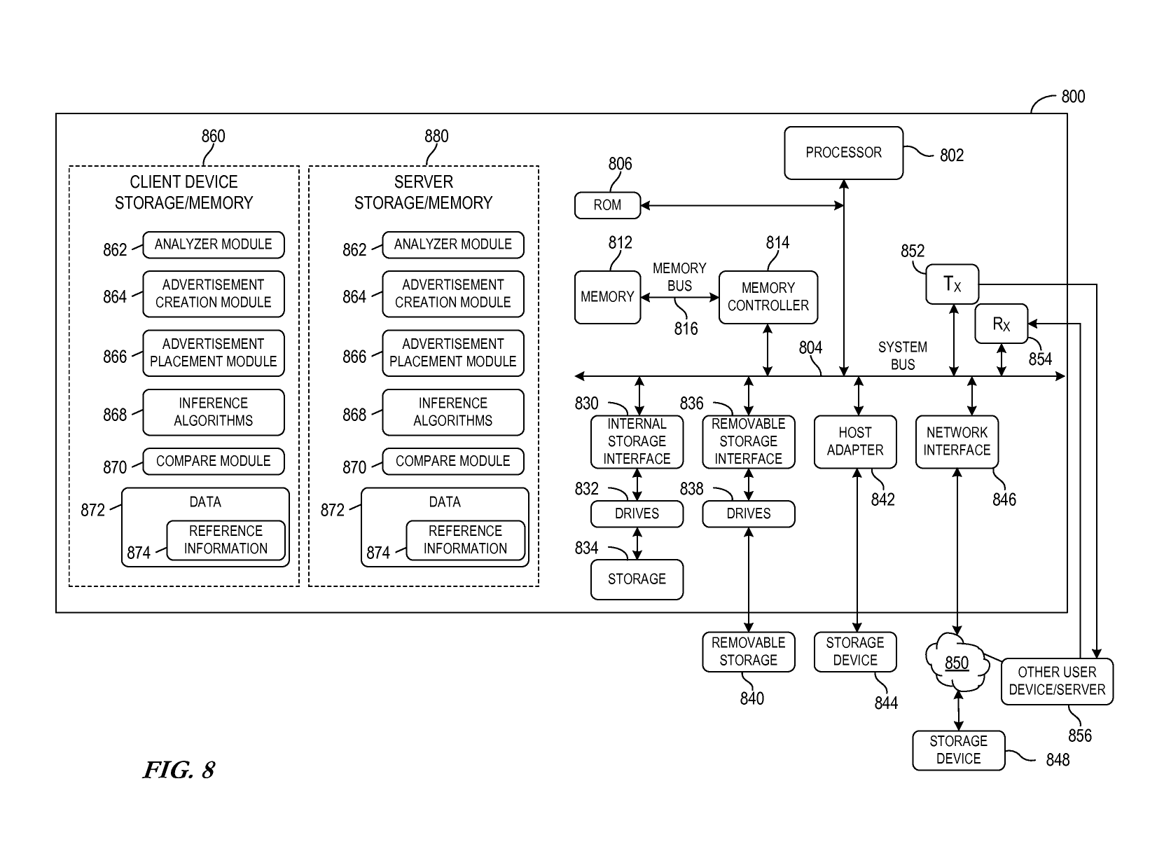

FIG. 8 depicts a representative computing system 800 in which the principles described herein may be implemented. The representative computing system 800 can represent either a user/client device or a server (e.g. mail server, SMSC, etc.), with differences noted below. The computing environment described in connection with FIG. 8 is described for purposes of example, as the structural and operational disclosure for facilitating the creation of electronic advertisements from emails is applicable in any environment in which applications can be executed. It should also be noted that the computing arrangement of FIG. 8 may, in some embodiments, be distributed across multiple devices.

For both client devices and servers, the representative computing system 800 may include a processor 802 coupled to numerous modules via a system bus 804. The depicted system bus 804 represents any type of bus structure(s) that may be directly or indirectly coupled to the various components and modules of the computing environment. A read only memory (ROM) 806 may be provided to store firmware used by the processor 802. The ROM 806 represents any type of read-only memory, such as programmable ROM (PROM), erasable PROM (EPROM), or the like.

The host or system bus 804 may be coupled to a memory controller 814, which in turn is coupled to the memory 812 via a memory bus 816. The operational modules associated with the advertisement creation described herein may be stored in and/or utilize any storage, including volatile storage such as memory 812, as well as non-volatile storage devices. FIG. 8 illustrates various other representative storage devices in which applications, modules, data and other information may be temporarily or permanently stored. For example, the system bus may be coupled to an internal storage interface 830, which can be coupled to a drive(s) 832 such as a hard drive. Storage 834 is associated with or otherwise operable with the drives. Examples of such storage include hard disks and other magnetic or optical media, flash memory and other solid-state devices, etc. The internal storage interface 830 may utilize any type of volatile or non-volatile storage.

Similarly, an interface 836 for removable media may also be coupled to the bus 804. Drives 838 may be coupled to the removable storage interface 836 to accept and act on removable storage 840 such as, for example, floppy disks, optical disks, memory cards, flash memory, external hard disks, etc. In some cases, a host adaptor 842 may be provided to access external storage 844. For example, the host adaptor 842 may interface with external storage devices via small computer system interface (SCSI), Fibre Channel, serial advanced technology attachment (SATA) or eSATA, and/or other analogous interfaces capable of connecting to external storage 844. By way of a network interface 846, still other remote storage may be accessible to the computing system 800. For example, wired and wireless transceivers associated with the network interface 846 enable communications with storage devices 848 through one or more networks 850. Storage devices 848 may represent discrete storage devices, or storage associated with another computing system, server, etc. Communications with remote storage devices and systems may be accomplished via wired local area networks (LANs), wireless LANs, and/or larger networks including global area networks (GANs) such as the Internet.

A local email or other messaging client and a server device communicate information, such as emails, advertising information and/or created advertisements. Communications between user devices and server devices can be effected by direct wiring, peer-to-peer networks, local infrastructure-based networks (e.g., wired and/or wireless local area networks), off-site networks such as metropolitan area networks and other wide area networks, global area networks, etc. A transmitter 852 and receiver 854 are shown in FIG. 8 to depict the representative computing system's structural ability to transmit and/or receive data in any of these or other communication methodologies. The transmitter 852 and/or receiver 854 devices may be stand-alone components, may be integrated as a transceiver(s), may be integrated into or already-existing part of other communication devices such as the network interface 846, etc.

Where the computing system 800 represents a mail server or other messaging server where messages are received for deliver to the user device, information may be transmitted via the transmitter 852. Client and server devices may include a transmitter 852 and/or receiver 854, which can be provided as discrete components or as part of a transceiver, and can be provided as stand-alone devices or integrated with another component such as the network interface 846. Communication between user devices and servers may utilize both of their transmitters 852 and receivers 854. As computing system 800 can be implemented at a user device or server, block 856 represents the user device or server that is communicating with the computing system 800 that represents the other of the two.

Where the representative computing system 800 represents a user device, the memory 812 and/or storage 834, 840, 844, 848 may be used to store programs and data used in connection with the user device's analysis and ad creation techniques previously described. The client device storage/memory 860 represents what may be stored in memory 812, storage 834, 840, 844, 848, and/or other data retention devices. The representative client device storage/memory 860 may include an operating system (not shown), and processor-implemented functions represented by functional modules. For example, modules previously described include an analyzer module 862, advertisement creation module 864, advertisement placement module 866, inference algorithm(s) 868, compare module 870, and data 872. The data 872 may include reference information 874 that can be compared using compare module 870 to incoming email information to determine whether the incoming email meets the criteria for creating an advertisement therefrom.

Where the representative computing system 800 represents a server (e.g. a mail server), the memory 812 and/or storage 834, 840, 844, 848 may be used to store programs and data used in connection with the server's functional operations previously described. The server storage/memory 880 represents what may be stored in memory 812, storage 834, 840, 844, 848, databases, and/or other data retention devices. The representative server storage/memory 880 may include an operating system (not shown), one or more of the modules 862-870, data 872, etc. The determination of which modules are provided at the client device storage/memory 860 or server storage/memory 880 depends on where the respective responsibilities are to be placed.

As previously noted, the representative computing system 800 in FIG. 8 is provided for purposes of example, as any computing device having processing and communication capabilities can carry out the functions described herein using the teachings described herein. It should also be noted that the sequence of various functions in the flow diagrams or other diagrams depicted herein need not be in the representative order that is depicted unless otherwise noted.

As demonstrated in the foregoing examples, embodiments described herein facilitate the creation and presentation of electronic advertisements based on received email and other electronic communications. In various embodiments, methods are described that can be executed on a computing device, such as by providing software modules that are executable via a processor (which includes a physical processor and/or logical processor, controller, etc.). The methods may also be stored on computer-readable media that can be accessed and read by the processor and/or circuitry that prepares the information for processing via the processor. For example, the computer-readable media may include any digital storage technology, including memory 812, storage 834, 840, 844, 848, any other volatile or non-volatile digital storage, etc. Having instructions stored on a computer-readable media as described herein is distinguishable from having instructions propagated or transmitted, as the propagation transfers the instructions, versus stores the instructions such as can occur with a computer-readable medium having instructions stored thereon. Therefore, unless otherwise noted, references to computer-readable media/medium having instructions stored thereon, in this or an analogous form, references tangible media on which data may be stored or retained.

Although the subject matter has been described in language specific to structural features and/or methodological acts, it is to be understood that the subject matter defined in the appended claims is not necessarily limited to the specific features or acts described above. Rather, the specific features and acts described above are disclosed as representative forms of implementing the claims.

What is claimed is:

1. Computer-readable media having instructions stored thereon which are executable by a computer system for performing:
determining that a received electronic communication includes advertisement information;
identifying one or more elements of the electronic communication that may be used in an electronic advertisement; and
creating the electronic advertisement using at least the identified one or more elements of the electronic communication.

2. The computer-readable media of claim 1, wherein the electronic communication comprises electronic mail (email).

3. The computer-readable media of claim 2, further comprising deleting the received electronic communication in connection with the creation of the electronic advertisement.

4. The computer-readable media of claim 1, wherein determining that the electronic communication includes advertisement information comprises parsing information from the electronic communication, and analyzing the parsed information to identify data that expressly indicating that the electronic communication includes the advertisement information.

5. The computer-readable media of claim 4, wherein identifying data that expressly indicating that the electronic communication includes the advertisement information comprises identifying at least some of the data in a header of the electronic communication.

6. The computer-readable media of claim 4, wherein identifying data that expressly indicating that the electronic communication includes the advertisement information comprises identifying at least some of the data in a dedicated multipurpose internet mail extensions (MIME) type.

7. The computer-readable media of claim 4, wherein identifying data that expressly indicating that the electronic communication includes the advertisement information comprises identifying at least some of the data in a body of the electronic communication using at least one data tag.

8. The computer-readable media of claim 1, wherein determining that the electronic communication includes advertisement information comprises parsing information from the electronic communication, analyzing the parsed information, and inferring from the parsed information that the electronic communication includes the advertisement information.

9. The computer-readable media of claim 8, wherein inferring from the parsed information comprises comparing stored reference information indicative of a solicitation to information provided in the electronic communication.

10. The computer-readable media of claim 1, further comprising providing a link to the electronic communication from the created electronic advertisement.

11. An apparatus comprising:
a receiver configured to receive an electronic message addressed to a targeted recipient;
an analyzer module configured to receive the electronic message and to determine whether the electronic message communicates information that can be formulated into an electronic advertisement; and
an advertisement creation module configured to receive the information and to create the electronic advertisement using at least the information, if the electronic message included the information.

12. The apparatus of claim 11, wherein the receiver, the analyzer module, and the advertisement creation module are implemented at a user device of the targeted recipient, and further comprising an advertisement placement module configured to cause the electronic advertisement to be presented via the user device.

13. The apparatus of claim 11, wherein the receiver, the analyzer module and the advertisement creation module are implemented at a message server in a communication path between a source of the electronic message and a user device of the targeted recipient.

14. The apparatus of claim 13, further comprising a transmitter configured to transmit the electronic advertisement to the user device.

15. The apparatus of claim 13, further comprising a transmitter configured to transmit the electronic advertisement to an advertisement platform for ultimate presentation at the user device.

16. A computer-implemented method comprising:
receiving via a receiver an electronic mail (email) addressed for a targeted device;
analyzing at least some of the data in the email using a processor to determine whether the email includes data expressly indicating that it is an advertising email that includes advertising information;
parsing advertising content from the email using the processor, if the email is determined to be an advertising email;
creating an electronic advertisement using the processor and at least the advertising content from the email; and
facilitating presentation of the created electronic advertisement on the targeted device.

17. The computer-implemented method of claim 16, wherein receiving an email comprises receiving the email at the targeted device, wherein the targeted device receives the email, analyzes the at least some of the data, parses the advertising content from the email, creates the electronic advertisement, and enables the created electronic advertisement to be at least visually displayed at the targeted device.

18. The computer-implemented method of claim 16, wherein receiving an email comprises receiving the email at a mail server of the targeted device, wherein the mail server performs the analyzing, parsing and creating, and wherein facilitating presentation of the created electronic advertisement comprises transmitting the electronic advertisement to an address of the targeted device for presentation.

19. The computer-implemented method of claim 18, further comprising sending the advertising information from the mail server to an advertisement server to facilitate the creation of the electronic advertisement, and the presentation of the created electronic advertisement on the targeted device.

20. The computer-implemented method of claim 18, further comprising sending the created electronic advertisement to an advertisement server to facilitate the presentation of the created electronic advertisement on the targeted device.
